(19) United States
(12) Patent Application Publication
(10) Pub. No.: US 2026/0338643 A1
(43) Pub. Date: Oct. 29, 2026

(54) PORTABLE TIRE PREP DETECTOR AND ASSOCIATED METHOD OF USE

(71) Applicant: Red Rock Racing Industries, LLC, Pella, IA (US)

(72) Inventor: Dennis Ray Fogle, Pella, IA (US)

(21) Appl. No.: 19/379,155

(22) Filed: Nov. 4, 2025

Related U.S. Application Data
(60) Provisional application No. 63/793,081, filed on Apr. 23, 2025.

(51) Int. Cl. G01M 17/02; G01N 25/00

(52) U.S. Cl. CPC G01M 17/027; G01N 25/00

(57) ABSTRACT

A portable tire prep (or dope) detector is used to detect prep on a tire at a track, immediately after a race. The detection of prep involves a test that takes less than two minutes. Multiple tires can be reliably tested in this way in rapid succession. The portable tire prep detector can be a rolling chamber with a laser and camera that the test tire is placed. The laser is directed at the tire. The light energy from the laser heats up the tire and produces out-gassing visible by the camera. The camera provides a real time viewing of this outgassing. The time it takes to detect outgassing from the instance the light is projected onto the tire determines if the tire has been prepped. If the time is shorter than the same test performed on a control tire, then the tire is determined to have been prepped.

### CROSS REFERENCE TO RELATED APPLICATIONS

This application claims priority under 35 U.S.C. § 119(e) to provisional patent application U.S. Serial No. 63/793,081, filed Apr. 23, 2025. The provisional patent application is hereby incorporated by reference in its entirety herein, including without limitation: the specification, claims, and abstract, as well as any figures, tables, appendices, or drawings thereof.

### TECHNICAL FIELD

The present disclosure relates generally to a portable tire prep (or dope) detector and/or a method for testing racing tires for the presence of prep (or dope) having applications in at least the racing or motorsport industry. More particularly, but not exclusively, the present disclosure relates to a portable tire prep detector and associated method of use.

### BACKGROUND

The background description provided herein gives context for the present disclosure. Work of the presently named inventors, as well as aspects of the description that may not otherwise qualify as prior art at the time of filing, are neither expressly nor impliedly admitted as prior art.

In motor racing, from small amateur go cart races for teenagers up to NASCAR races for professional race car drivers, the racing vehicles are generally required to use OEM (Original Equipment Manufacturer) stock tires. It is often against racing rules to treat the OEM tires with any chemicals or solvents that will alter the performance characteristics of the tire so as to improve an ability of the tires to adhere to the track or limit wear. Allowing such treatment of tires may give some racers an unfair advantage. Despite such prohibitions, a small industry has nevertheless developed that sells chemicals that can be absorbed into the rubber material of the tire and will alter the rubber material of the tire. These chemicals, referred to here as “prep” or “dope”, generally involve mixtures of hydrocarbon liquids and/or other solvents that alter OEM synthetic rubber. Racing organizations have been trying to develop techniques to catch individuals who are disregarding the racing rules and are cheating by treating their tires with prep.

For example, after particularly important races, tires of the winning vehicles will have samples of the rubber cut from the tire, and the samples are shipped to a remote laboratory, which are then tested using a gas chromatograph to test for the presence of prep. This type of testing is undesirably expensive and slow.

Parallel to the anti-prep rule, some tracks have a rule that states a minimum softness or durometer value on certain tires on the race vehicle. Accordingly, a handheld device called a durometer is sometimes used. The durometer does not actually detect tire prep, but rather measures the result of using tire prep on a tire, namely the resulting softness of the tire. To use a durometer, a track official typically presses the durometer against the tire such that the durometer compresses a small certain amount of rubber of the tire. The durometer indicates the amount of force required to carry out the compression. Use of durometers to detect tire prep has not been very satisfactory and many cheaters have managed to avoid detection. Some preps do not cause ordinary tire material to soften in a particular way that is detectable by the durometer. A durometer may not detect an unusually soft tire, yet the tire has nevertheless been treated and is significantly more porous and stickier than an untreated tire.

In fact, it has been so difficult to catch cheaters that some racing organizations have been only half-heartedly attempting to enforce prohibitions on the use of prep. Many prep mixtures include constituents such as hexane, xylene, toluene, acetone, mineral spirits, paint thinner, transmission fluid, other hydrocarbons, toxic substances, carcinogenic-substances, and flammable substances. At a racetrack, once a cheater has applied prep to his/her tires, the cheater might be induced to dump the excess prep material on the ground or down a drain in order to avoid being caught with the illicit material. Such dumping causes pollution around the racetrack and may require the racetrack to engage in a costly cleanup.

One way of preventing the use of prep is to require racers to purchase a set of racing tires at the track. These tires, once purchased, must be put on the racing vehicle in plain sight, and then the vehicle with the purchased tires is made to enter the race. The tires are then impounded after the race and locked up at the track facility. The tires are used a few races and then replaced at the competitor’s expense. Due to the open visibility of the tire during this entire process, it is difficult for a cheater to apply prep without being detected. Although this technique can be practiced in auto races of well-known racing organizations where professionals are involved, requiring an amateur racer with less financial backing to purchase a new set of new tires before every few weeks can be prohibitive. An amateur go cart racer may not be able to afford purchasing a new set of tires multiple times a year when the racing is only done for recreational purposes.

Moreover, even at high visibility professional races of national importance, a prepping problem may still occur. Despite the fact that the race teams can be required to buy new stock tires at the racetrack, and despite the fact that race teams are required to put the purchased tires on their race cars in plain sight, each racing pit typically has its own air compressor to inflate tires. Some cheaters have reportedly gone to the trouble of modifying their air compressor so that the outer visible tank includes an inner tank, and the inner tank includes prep. As the tire is inflated in the pit using the air compressor, prep from the inner tank is secretly injected into the stock tire. The injected prep then serves to soften the tire from the inside out as the race proceeds, thereby giving the race team an unfair advantage.

Thus, there exists a need in the art for testing be done on the spot at the track for timely results and accurate placement of competitor finish positions in addition to a technique of keeping people from cheating without having to force all racers to buy new tires prior frequently. Additionally, it is desirable to have an inexpensive and reliable technique for detecting tires treated with tire prep.

### SUMMARY

The following objects, features, advantages, aspects, and/or embodiments are not exhaustive and do not limit the overall disclosure. No single embodiment need provide each and every object, feature, or advantage. Any of the objects, features, advantages, aspects, and/or embodiments disclosed herein can be integrated with one another, either in full or in part.

In a novel method, a portable tire prep detector is used to detect prep on a tire. In one example, the prep is on a tire that is on a racing vehicle (for example, a go cart or race car), and the racing vehicle is at a racetrack. The detection of prep using the portable tire prep detector involves a test that takes two minutes or less to perform. Multiple tires can be reliably tested in this way for prep at the racetrack using the portable tire prep detector, even if some of the tires tested are exhibiting high concentrations of prep.

In one example, the portable tire prep detector is a rolling chamber including a laser and a camera. The suspect tire is removed from the racing vehicle and placed into the chamber. The camera is able to detect outgassing of tire prep activated by laser energy. The timing of the outgassing detected by the camera determines if the tire has been prepped If the detected time is less than the detected time of testing a new OEM tire of same make/model, then the tire is determined to have been prepped. If, on the other hand, the tire is tested to generate outgassing in same or above the time as the OEM tire, then the tire is determined not to have been prepped. Keeping the actual times that will result in a tire being deemed to have been prepped a secret, and not disclosing how the laser light creates the outgassing helps prevent cheaters from designing protocols to get prepped tires to test within the time limits of the unaltered OEM tire.

It is a primary object, feature, and/or advantage of the present disclosure to improve on or overcome the deficiencies in the art. Additionally, it is preferred the apparatus be safe, cost effective, and durable.

Methods can be practiced which facilitate use, manufacture, assembly, maintenance, and repair of the tire prep detector which accomplish some or all of the previously stated objectives.

According to some aspects of the present disclosure, a method for detecting a presence of tire prep for vehicles, wherein the method includes in an isolated environment directing a laser at a tire within the isolated environment while monitoring the tire and then calculating a time from when the laser is activated until smoke is detected at or near the tire. In this method the calculated time is used to determine the presence of tire prep on the tire.

According to some additional aspects of the present disclosure, comparing the calculated time to a database comprising known amounts of time for smoke to be detected after the laser has been actuated.

According to some additional aspects of the present disclosure, a known amount of time comprises a control time for smoke to be detected based on a type of tire being monitored.

According to some additional aspects of the present disclosure, if smoke is detected in an amount of time less than the control time, then the tire has been prepped.

According to some additional aspects of the present disclosure, the prepped tire comprises the addition of any of hexane, xylene, toluene, acetone, mineral spirits, paint thinner, transmission fluid, hydrocarbons to the tire prior to monitoring the tire.

According to some additional aspects of the present disclosure, further comprising cleaning the tire before placing the tire in the isolated environment.

According to some additional aspects of the present disclosure, further comprising positioning the tire a set distance from the laser before actuating the laser.

According to some additional aspects of the present disclosure, further comprising positioning the tire such that the laser will contact the tire orthogonal to a surface of the tire when actuated.

According to some additional aspects of the present disclosure, the monitoring happens via a sensor located in the isolated environment.

According to some additional aspects of the present disclosure, the sensor is a camera.

According to some additional aspects of the present disclosure, communicating a live feed from the sensor via a monitor positioned outside of the isolated environment.

According to some additional aspects of the present disclosure, the isolated environment is positioned on a cart.

According to some additional aspects of the present disclosure, the laser comprises a 5W laser.

According to some other aspects of the present disclosure, a system for detecting a presence of tire prep for vehicles, including a housing, a platform positioned within the housing, a first linear translator for altering a position of the platform, a laser positioned within the housing, a second linear translator for altering a position of the laser, and a sensor positioned within the housing. The platform is configured to secure and uphold a tire from a vehicle for interaction with the laser and monitoring from the sensor.

According to some additional aspects of the present disclosure, comprising a timer operatively connected to the housing.

According to some additional aspects of the present disclosure, comprising a monitor positioned outside the housing for viewing live feed from the sensor.

According to some additional aspects of the present disclosure, the sensor is a camera.

According to some additional aspects of the present disclosure, the housing is positioned on top of a movable cart.

According to some additional aspects of the present disclosure, the housing is positioned on top of a sturdy platform.

According to some additional aspects of the present disclosure, the laser comprises a 5W laser.

According to some other aspects of the present disclosure, a method for detecting a presence of tire prep for vehicles, including having access to a database of control times for an amount of time it takes to cause a tire to begin producing smoke when exposed to a laser, positioning the laser a predetermined distance from the tire based on a distance of the laser from tires that resulted in the control times in the database, actuating the laser after the laser is correctly positioned with respect to the tire, starting a timer simultaneously with actuating the laser, stopping the timer when smoke begins to rise from the tire, noting a comparison time between starting the timer and stopping the timer, comparing the comparison time to at least one of the control times from the database, and determining the tire has been prepped if the comparison time is lower than the at least one control time from the database.

These and/or other objects, features, advantages, aspects, and/or embodiments will become apparent to those skilled in the art after reviewing the following brief and detailed descriptions of the drawings. The present disclosure encompasses (a) combinations of disclosed aspects and/or embodiments and/or (b) reasonable modifications not shown or described.

### BRIEF DESCRIPTION OF THE DRAWINGS

Several embodiments in which the present disclosure can be practiced are illustrated and described in detail, wherein like reference characters represent like components throughout the several views. The drawings are presented for exemplary purposes and may not be to scale unless otherwise indicated.

FIG. 1 shows a schematic view of a tire prep detector according to aspects of the present disclosure.

FIG. 2 shows a schematic view of a wheeled tire prep detector according to aspects of the present disclosure.

An artisan of ordinary skill in the art need not view, within isolated figure(s), the near infinite distinct combinations of features described in the following detailed description to facilitate an understanding of the present disclosure.

### DETAILED DESCRIPTION

Unless defined otherwise, all technical and scientific terms used above have the same meaning as commonly understood by one of ordinary skill in the art to which embodiments of the present disclosure pertain.

The terms “a,” “an,” and “the” include both singular and plural referents.

The term “or” is synonymous with “and/or” and means any one member or combination of members of a particular list.

As used herein, the term “exemplary” refers to an example, an instance, or an illustration, and does not indicate a most preferred embodiment unless otherwise stated.

The term “about” as used herein refers to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variables, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

The present disclosure is not to be limited to that described herein. Mechanical, electrical, chemical, procedural, and/or other changes can be made without departing from the spirit and scope of the present disclosure. No features shown or described are essential to permit basic operation of the present disclosure unless otherwise indicated.

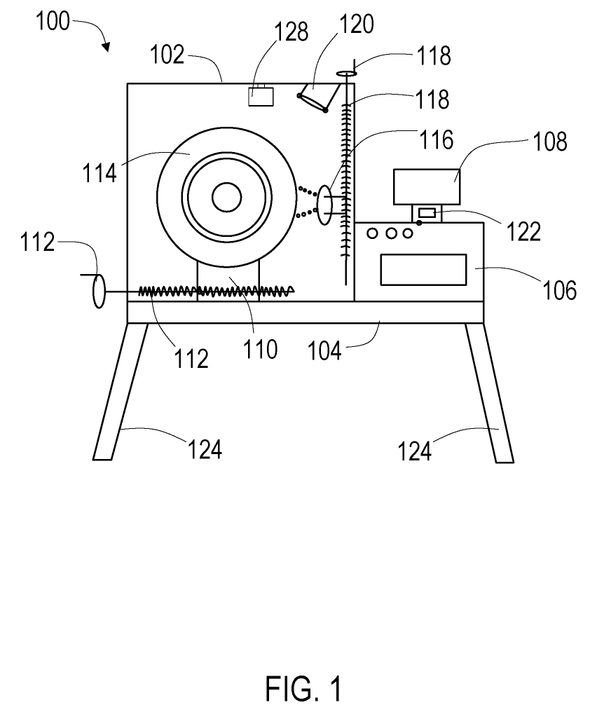

FIG. 1 shows a tire prep detector 100. The tire prep detector 100 can include a housing 102, a base 104, a controller 106, a monitor 108, platform 110, a platform translator 112, a tire 114, a laser 116, a laser translator 118, a sensor 120, a timer 122, legs 124, and a light source 128. The tire prep detector 100 is used to detect prep on a tire that has an inner diameter (rim diameter) of less than 12”.

The tire prep detector 100 includes the housing 102 which is configured to house the tire 114. The housing 102 is situated on top of the base 104. As shown in FIG. 1, the controller 106 is operatively connected to the housing 102 and is positioned adjacent the housing 102, in which the controller 106 is operatively connected to the monitor 108. Positioned within the housing 102, the platform 110 is configured to support the tire 114, in which the platform 110 is operatively connected to the platform translator 112. The platform translator 112 can be positioned on a bottom of the housing 102.

The housing 102 can comprise a clear, partially clear, or opaque material. For example, in some embodiments, the use of a see-through material (e.g., glass, Plexiglas, plastics, or other polymers) allow for the real time visualization of the testing of the detector 100. In other embodiments, the housing 102 can include opaque walls that mitigate light from the laser or other external factors from affecting the results of the test. It is also noted that the housing 102 be substantially airtight to mitigate the ability of external environmental (i.e., ambient conditions) to enter and potentially affect the testing.

Also positioned within the housing 102 is the laser 116. The laser is operatively connected to the laser translator 118. Each of the laser 116 and the laser translator 118 can be positioned on an interior surface of the housing 102 or a wall of the housing 102 within the housing 102. The laser 116 is configured to point at the platform 110 or at a position on the platform 110 which holds the tire 114. The laser 116 is configured to point at the tire 114. The tire prep detector 100 can further include the sensor 120 which can be a camera and can be positioned anywhere within the housing 102. The sensor 120 is configured to be directed towards a position of interfacing between the laser 116 and the tire 114. Alternatively, an operator can monitor the tire 114 without the sensor 120 via line of sight which can be through the housing 102.

The platform can comprise a generally horizontal support surface configured to receive the tire 114 for mounting thereon or a generally vertical support surface with hooks, flanges, or other protrusions thereon for hanging and/or securing the tire 114 thereto, thus facilitating mounting or demounting of the tire 114. The platform 110 can be circular, rectangular, polygonal, or irregular in shape, and can be planar, slightly concave, or feature localized recesses or projections to accommodate various wheel profiles for the tire 114. The platform can be by way of example a pedestal, frame, or integrated base structure at a height accessible to an operator within the housing 102. A central post, spindle, or hub can extend vertically from the base 104 at an interior of the housing 102 to align with a central bore of the tire 114, optionally including clamping elements such as threaded fasteners, expandable jaws, or cam-lock mechanisms to retain the tire 114 in a fixed position. Radially spaced or peripheral gripping arms can also be included, capable of radial movement and configured to secure the tire 114 within the housing 102.

Each of the platform translator 110 and the laser translator 118 can be a linear translator that includes a base and a movable element constrained to linear motion by guides such as rails, rods, or ways. Movement can be driven by a mechanism like a lead screw, ball screw, rack and pinion, linear motor, or pneumatic/hydraulic actuator. The guides can use sliding or rolling bearings, flexures, or magnetic systems. The translator can be manual or motorized, with optional encoders, stops, or limit switches. Variants can include anti-backlash devices, locks, preload adjustments, or integrated damping. Multiple translators can be stacked for multi-axis travel.

The tire prep detector 100 further includes the timer 122 which can be operatively connected to each of the controller 106, the monitor 108, the laser 116, and the camera 120 or alternatively manually operated separately from the tire prep detector 100 by an operator. The timer 122 can be positioned adjacent to the housing 102. Additionally, the tire prep detector 100 includes the legs 124 positioned beneath the base 104 so as to uphold the tire prep detector 100. Furthermore, the light source 128 can be positioned on an interior surface within the housing 102 and configured to point towards and illuminate an area surrounding the point of interaction between the laser 116 and the tire 114.

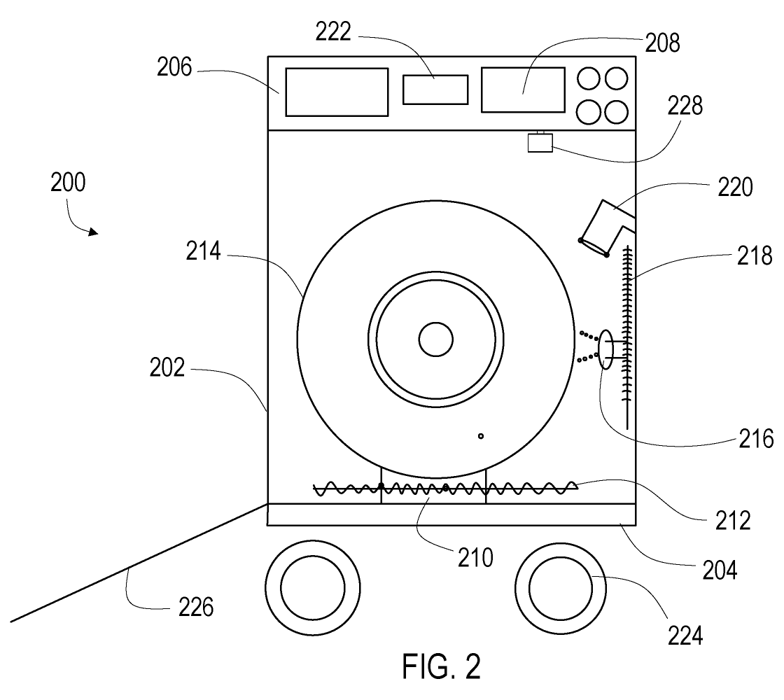

FIG. 2 shows a wheeled tire prep detector 200. The wheeled tire prep detector 200 can include a housing 202, a base 204, a controller 206, a monitor 208, platform 210, a platform translator 212, a tire 214, a laser 216, a laser translator 218, a sensor 220, a timer 222, wheels 224, a ramp 226, and a light source 228. The wheeled tire prep detector 200 is used to detect prep on a tire that has an inner diameter (rim diameter) of greater than 12”.

The wheeled tire prep detector 200 includes the housing 202 which is configured to house the tire 214. The housing 202 is situated on top of the base 204. As shown in FIG. 2, the controller 206 is operatively connected to the housing 202 and is positioned adjacent the housing 202, in which the controller 206 is operatively connected to the monitor 208. Positioned within the housing 202, the platform 210 is configured to support the tire 214, in which the platform 210 is operatively connected to the platform translator 212. The platform translator 212 can be positioned on a bottom of the housing 202.

The housing 202 can comprise a clear, partially clear, or opaque material. For example, in some embodiments, the use of a see-through material (e.g., glass, Plexiglas, plastics, or other polymers) allow for the real time visualization of the testing of the detector 200. In other embodiments, the housing 202 can include opaque walls that mitigate light from the laser or other external factors from affecting the results of the test. It is also noted that the housing 102 be substantially airtight to mitigate the ability of external environmental (i.e., ambient conditions) to enter and potentially affect the testing.

The platform can comprise a generally horizontal support surface configured to receive the tire 214 for mounting thereon or a generally vertical support surface with hooks, flanges, or other protrusions thereon for hanging and/or securing the tire 214 thereto, thus facilitating mounting or demounting of the tire 214. The platform 210 can be circular, rectangular, polygonal, or irregular in shape, and can be planar, slightly concave, or feature localized recesses or projections to accommodate various wheel profiles for the tire 214. The platform can be by way of example a pedestal, frame, or integrated base structure at a height accessible to an operator within the housing 202. A central post, spindle, or hub can extend vertically from the base 204 at an interior of the housing 202 to align with a central bore of the tire 214, optionally including clamping elements such as expandable jaws, threaded fasteners, or cam-lock mechanisms to retain the tire 214 in a fixed position. Radially spaced or peripheral gripping arms can also be included, capable of radial movement and configured to secure the tire 214 within the housing 202.

Each of the platform translator 210 and the laser translator 218 can be a linear translator that includes a base and a movable element constrained to linear motion by guides such as rails, rods, or ways. Movement can be driven by a mechanism like a lead screw, ball screw, rack and pinion, linear motor, or pneumatic/hydraulic actuator. The guides can use sliding or rolling bearings, flexures, or magnetic systems. The translator can be manual or motorized, with optional encoders, stops, or limit switches. Variants can include anti-backlash devices, locks, preload adjustments, or integrated damping. Multiple translators can be stacked for multi-axis travel.

Also positioned within the housing 202 is the laser 216. The laser is operatively connected to the laser translator 218. Each of the laser 216 and the laser translator 218 can be positioned on a side of the housing 202 or a wall of the housing 202 within the housing 202. The laser 216 is configured to point at the platform 210 or at a position on the platform 210 which holds the tire 214. The laser 216 is configured to point at the tire 214. The wheeled tire prep detector 200 can further include the sensor 220 which can be a camera and can be positioned anywhere within the housing 202. The sensor 220 is configured to be directed towards a position of interfacing between the laser 216 and the tire 214. Alternatively, an operator can monitor the tire 214 without the sensor 220 via line of sight which can be through the housing 202.

The wheeled tire prep detector 200 further includes the timer 222 which can be operatively connected to each of the controller 206, the monitor 208, the laser 216, and the camera 220 or alternatively manually operated separately from the tire prep detector 200 by an operator. The timer can be positioned adjacent to the housing 202. Additionally, the wheeled tire prep detector 200 includes the wheels 224 positioned beneath the base 204 so as to uphold the wheeled tire prep detector 200 and allow for translational movement along a surface or ground. The wheeled tire prep detector 200 additionally includes the ramp 226 operatively attached to the housing 202 which can operate as a door to the housing 202 or simply as a component to assist with elevating the tire 214 into the housing 202 and onto the platform 210. Furthermore, the light source 228 can be positioned on an interior surface within the housing 202 and configured to point towards and illuminate an area surrounding the point of interaction between the laser 216 and the tire 214.

To use the (wheeled) tire prep detector 100, 200, an operator selects the tire 114, 214 for testing from a racecar or other vehicle used for racing purposes. Either an entirety of the tire 114, 214 (which can include a wheel of the tire 114, 214) or a portion of the tire 114, 214 is removed from the racecar or other vehicle and transported into the housing 102, 202 and onto the platform 110, 210. The tire 214 can be rolled up the ramp 226 and onto the platform 210. Once the tire 114, 214 is secured on the platform 110, 210 the operator can adjust a position of the tire 114, 214 by adjusting a position of the platform 110, 210 with the platform translator 112, 212. The platform translator 112, 212 can be a linear translator or a plurality of linear translators. The platform translator 112, 212 can be operatively connected to the controller 106, 206 or alternatively can function separately as its own component. Additionally, the operator can position the laser 116, 216 with the laser translator 118, 218. The laser translator 118, 218 can be a linear translator or a plurality of linear translators. The laser translator 118, 218 can be operatively connected to the controller 106, 206 or alternatively can function separately as its own component. It is desirable that the operator position the platform 110, 210 such that a position of interfacing on the tire 114, 214 is a consistent distance away from an origination point of the laser 116, 216 for various iterations of testing between separate tires within the (wheeled) tire prep detector 100, 200. It is additionally preferable to have the laser 116, 216 interface with the tire 114, 214 approximately orthogonal to an outer surface of the tire 114, 214.

The operator then seals the housing 102, 202 (which can occur by way of closing the ramp 226) with the tire 114, 214 positioned therein, or alternatively the operator can first seal the housing 102, 202 and then position the tire 114, 214 by way of using the sensor 120, 220 when the sensor is a camera and monitoring the position thereof via the monitor 108, 208. The sensor 120, 220 can comprise a plurality of sensors, and the sensors 120, 220 can be operatively connected to the controller 106, 206.

The operator then begins testing by turning on the laser 116, 216 which triggers the timer 122, 222 to start. The sensor(s) 120, 220 will monitor the laser interacting with the tire 114, 214 while displaying results of the sensor(s) 120, 220 on the monitor 108, 208. The timer 122, 222 will then stop once smoke is detected from the tire from the point of interfacing between the tire 114, 214 and the laser 116, 216. The sensor 120, 220 can be a smoke detector but is preferably a high-resolution camera for visually detecting near instantaneously a moment that smoke emits from the tire 114, 214. Having the concentrated laser 116, 216 beam at a diameter consistent between testing of separate tires at the predetermined and consistent distance away from the tire 114, 214 gives the opportunity to see a difference in doped vs undoped tires. The operator will then compare a time from the timer 122, 222 resulting from start to stop (when smoke was detected) with times recorded in a database. The times in the database can be included in the controller 106, 206 or stored elsewhere separately. Times for specific types of dope known to be used for cheating can be recorded in the database for tires of the tire model type being monitored and tested, and the database will include a control time for time-till-smoke at least generally for all tires but more preferably for multiple models of tires known to produce smoke when not prepped or doped. If the time-till-smoke recorded by the timer 122, 222 for the tire 114, 214 being monitored was less than (or faster than) the control time, then the tire 114, 214 is determined to have been doped or prepped. This is due to liquid or gaseous substances injected into the tire 114, 214 that alter the tire 114, 214 (often including softening the tire 114, 214) and alter the time-till-smoke such that the time-till-smoke is faster from causing the liquid or gaseous substance to smoke from the tire (and/or additionally causing the tire 114, 214 itself to smoke due to entanglement with the liquid or gaseous substance).

Preferably, the laser 116, 216 is a 5W power laser 116, 216. Laser powers above this can speed up the time-till-smoke for all testing and monitoring and can make difficult the detection of minute differences in time-till-smoke, whereas laser powers below the 5W can make waiting for results take longer. As such, the 5W power is preferable, however higher and lower powered lasers can be used based on a preference of the user/operator should the operator desire faster testing times (higher powered laser) or greater detection accuracy of time differences in time-till-smoke (lower powered laser).

It is preferred that the tire 114, 214 be cleaned prior to monitoring and testing. Dirt and debris can be one factor that can cause inaccurate readings should the laser 116, 216 penetrate substances not originating from the tire that could have been cleaned off. Additionally, it is preferable that operators test the tire 114, 214 with consistent surface temperatures of the tire specimen. In one embodiment it is preferable to have ranges of control times for tires 114, 214 time-till-smoke based on environments of cold environments and hot environments. Alternatively, the (wheeled) tire prep detector 100, 200 can include a climate-controlled interior once sealed to allow for a consistent tire temperature environment within the (wheeled) tire prep detector 100, 200. While racing can occur in both cold and hot environments, if timed correctly the tire(s) 114, 214 taken off vehicles after a race and placed speedily in the (wheeled) tire prep detector 100, 200 can have fairly consistent hot temperatures as opposed to allowing the tire 114, 214 to cool to whatever the surrounding environment may be (110-degrees Fahrenheit or 10-degrees Fahrenheit) thus adding to accuracy and consistency in testing for differences in time-till-smoke. Cleaning the tire 114, 214 with a consistent water temperature instead of immediately taking tire to housing 102, 202 can also contribute to consistent tire temperatures. Testing tires without cleaning and without controlling for temperature can still produce results that unveil doped tires as there is still a noticeable difference between a doped tire and a regular tire with the doped tire 114, 214 producing times-till-smoke noticeably shorter than regular tires 114, 214 (same as the control tire), but will not give as meticulously accurate of results.

Furthermore, while it is possible for operators to simulate monitoring and testing of the tires via the laser 116, 216 directly pointed at the tire 114, 214 while the tire 114, 214 is still attached to the vehicle, this method is susceptible to inaccurate results and thus placing the tire 114, 214 or a portion thereof within the housing 102, 202 is recommended due to control of air currents and safety. Using the 5W power laser 116, 216 in an uncontrolled environment can pose a safety threat to users not well trained or to surprise factors such as others not aware of what is going. Additionally, being able to see smoke is enhanced without air currents as movement of the smoke (dispersion thereof) requires minimal outside air currents. As such, if it is a windy day, the operator may not be able to see the smoke at exact time it occurs, which is an additional reason that it is preferred to test within the housing 102, 202. Lighting is an additional factor that contributes to seeing the smoke and can be inconsistent outside of the housing 102, 202 thus resulting in inaccurate readings when monitoring via laser outside of the housing 102, 202. As such, the (wheeled) tire prep detector 100, 200 can further comprise lighting positioned within the housing and aimed at the position of interfacing between the tire 114, 214 and the laser 116, 216. For these reasons, the (wheeled) tire prep detector 100, 200 includes the housing 102, 202 as a controlled environment for consistent testing.

The (wheeled) tire prep detector 100, 200 provides for quick and accurate testing to be done on the spot at the track for timely results and accurate placement of competitor finish positions in addition to a technique of keeping racers from cheating without having to force all racers to buy new tires prior frequently. Additionally, the (wheeled) tire prep detector 100, 200 provides for an inexpensive and reliable technique for detecting tires treated with tire prep.

FIGS. 1 and 2 are diagrams of a portable tire prep detector that is used to detect illegal chemicals applied to race tires in which the tire prep is on or in the tire 114, 214. Portable tire prep detector in FIG. 1 may, for example, be a device that weighs less than 70 pounds and that detects the application of illegal chemicals on race tires. Portable tire prep detector in FIG. 2 may, for example, be a device on a rolling cart that has the same function as the device in FIG. 1 but accommodates larger tires. The tire is placed in a chamber or housing 102, 202. Although there are many different types of tire prep material, most tire prep materials include flammable constituent materials such as hydrocarbons. Accordingly, the detector contains the laser 116, 216 which projects laser radiation to a portion of the tire 114, 214. The light energy heats a portion of the tire until it combusts. The camera 120 videos this combustion and it is displayed on monitor 108, 208. The monitor 108, 208 will display the combustion in the form of smoke. At the time the laser energy is directed onto the tire, a timer 122, 222 is started. When smoke is observed on the monitor 108, 208 the timer 122, 222 is stopped. The time to combust on the sample tire 114, 214 compared to a new, unused tire determines if the tire has been prepped. The laser controller 106, 206 is used to control the on/off and energy output of the laser. The linear translator for the laser 116 aligns the laser beam to desired sample spot on the tire. The linear translator 112, 212 for the tire sets the sample surface of the tire 114, 214 at the required distance from the output of the laser. The distance of the laser from the tire and where the laser 116, 216 projects onto the tire 114, 214 contributes to consistent accuracy.

A database is created by testing the same model of new tires run at a particular track or sanctioning body. When a race car or kart is finished with a race or qualifying event, a tire 114, 214 can be removed from the car and placed in the housing 102, 202 and tested for the presence of tire prep. If the time to combust is less than the time it took the new tires in the database to combust, the tire is determined to have the presence of tire prep. The track then decides if the competitor is disqualified from the event or if their finishing order is negated. This decision determines the integrity of the racing event in whether the officials enforce the posted rules and eliminate this method of cheating at their event.

The database is a structured set of data typically held in a computer. The database, as well as data and information contained therein, need not reside in a single physical or electronic location. For example, the database may reside, at least in part, on a local storage device, in an external hard drive, on a database server connected to a network, on a cloud-based storage system, in a distributed ledger (such as those commonly used with blockchain technology), or the like.

Although the portable tire prep detector of FIGS. 1 and 2 is a device that involves a laser and video monitor, other suitable portable tire prep detectors can be employed in the novel method. Any one of the following monitor devices can be employed. Portable gas detector, smoke detector, photo ionization sensor, a metal oxide semiconductor sensor, a catalytic semiconductor sensor, an FID (flame ionization) sensor, and an ion mobility sensor. Sensors also could be combined with a portable GC (gas chromatograph) to detect specific chemicals. Portable tire prep detector may be a portable mass spectrometer or a portable chemical analysis detector. Absorption spectroscopy can be used to detect prep in a portable tire prep detector. The term portable tire prep detector embraces and encompasses all these techniques as well as any other suitable technique.

The controller 106, 206 can include an intelligent control which could be a CPU based component such as a user display, which can be an interactive and/or graphical user display for the monitor 108, 208. Examples of such intelligent control units may be tablets, telephones, handheld devices, laptops, user displays, or generally any other computing device capable of allowing input, providing options, and showing output of electronic functions. Still further examples include a microprocessor, a microcontroller, or another suitable programmable device) and a memory. The controller also can include other components and can be implemented partially or entirely on a semiconductor (e.g., a field-programmable gate array (“FPGA”)) chip, such as a chip developed through a register transfer level (“RTL”) design process. The memory includes, in some embodiments, a program storage area and a data storage area. The program storage area and the data storage area can include combinations of different types of memory, such as read-only memory (“ROM”), random access memory (“RAM”) (e.g., dynamic RAM (“DRAM”), synchronous DRAM (“SDRAM”), etc.), electrically erasable programmable read-only memory (“EEPROM”), flash memory, a hard disk, an SD card, or other suitable magnetic, optical, physical, or electronic memory devices.

The monitor 108, 208 can include a display (e.g., a primary display, a secondary display, etc.) and input devices (e.g., touch-screen displays, a plurality of knobs, dials, switches, buttons, etc.). More specifically, the display can be, for example, a liquid crystal display (“LCD”), a light-emitting diode (“LED”) display, an organic LED (“OLED”) display, an electroluminescent display (“ELD”), a surface-conduction electron-emitter display (“SED”), a field emission display (“FED”), a thin-film transistor (“TFT”) LCD, or a reflective bistable cholesteric display (i.e., e-paper).

It should be noted that the camera 120 can take many forms. For example, optical devices, temperature sensors, light sensors, or some combination thereof could be used to determine the presence of smoke or heat emitting from the tire upon application of the laser.

Although certain specific embodiments are described above for instructional purposes, the teachings of this patent document have general applicability and are not limited to the specific embodiments described above. Accordingly, various modifications, adaptations, and combinations of various features of the described embodiments can be practiced without departing from the scope of the invention as set forth in the claims.

From the foregoing, it can be seen that the present disclosure accomplishes at least all of the stated objectives.

1. A method for detecting a presence of tire prep for vehicles, comprising:
in an isolated environment, directing a laser at a tire within the isolated environment while monitoring the tire;
calculating a time from when the laser is activated until smoke is detected at or near the tire;
wherein the calculated time is used to determine the presence of tire prep on the tire.

2. The method of claim 1, further comprising comparing the calculated time to a database comprising known amounts of time for smoke to be detected after the laser has been actuated.

3. The method of claim 2, wherein a known amount of time comprises a control time for smoke to be detected based on a type of tire being monitored.

4. The method of claim 3, wherein if smoke is detected in an amount of time less than the control time, then the tire has been prepped.

5. The method of claim 4, wherein the prepped tire comprises the addition of any of hexane, xylene, toluene, acetone, mineral spirits, paint thinner, transmission fluid, hydrocarbons to the tire prior to monitoring the tire.

6. The method of claim 1, further comprising cleaning the tire before placing the tire in the isolated environment.

7. The method of claim 1, further comprising positioning the tire a set distance from the laser before actuating the laser.

8. The method of claim 7, further comprising positioning the tire such that the laser will contact the tire orthogonal to a surface of the tire when actuated.

9. The method of claim 1, wherein the monitoring happens via a sensor located in the isolated environment.

10. The method of claim 9, wherein the sensor is a camera.

11. The method of claim 9, further comprising communicating a live feed from the sensor via a monitor positioned outside of the isolated environment.

12. The method of claim 1, wherein the laser comprises a 5W laser.

13. A system for detecting a presence of tire prep for vehicles, comprising:
a housing;
a platform positioned within the housing;
a first linear translator for altering a position of the platform;
a laser positioned within the housing;
a second linear translator for altering a position of the laser; and
a sensor positioned within the housing;
wherein the platform is configured to secure and uphold a tire from a vehicle for interaction with the laser and monitoring from the sensor.

14. The system of claim 13, further comprising a timer operatively connected to the housing.

15. The system of claim 13, further comprising a monitor positioned outside the housing for viewing live feed from the sensor.

16. The system of claim 15, wherein the sensor is a camera.

17. The system of claim 13, wherein the housing is positioned on top of a movable cart.

18. The system of claim 13, wherein the housing is positioned on top of a sturdy platform.

19. The system of claim 13, wherein the laser comprises a 5W laser.

20. A method for detecting a presence of tire prep for vehicles, comprising:
having access to a database of control times for an amount of time it takes to cause a tire to begin producing smoke when exposed to a laser;
positioning the laser a predetermined distance from the tire based on a distance of the laser from tires that resulted in the control times in the database;
actuating the laser after the laser is correctly positioned with respect to the tire;
starting a timer simultaneously with actuating the laser;
stopping the timer when smoke begins to rise from the tire;
noting a comparison time between starting the timer and stopping the timer;
comparing the comparison time to at least one of the control times from the database; and
determining the tire has been prepped if the comparison time is lower than the at least one control time from the database.
